(19) United States
(12) Patent Application Publication
(10) Pub. No.: US 2024/0422550 A1
(43) Pub. Date: Dec. 19, 2024

(54) PAIRING METHOD FOR SENSOR AND GATEWAY

(71) Applicant: LG INNOTEK CO., LTD., Seoul (KR)

(72) Inventors: Hong Bum SON, Seoul (KR); Yong Taek OH, Seoul (KR); Jin Kuk LEE, Seoul (KR)

(73) Assignee: LG INNOTEK CO., LTD., Seoul (KR)

(21) Appl. No.: 18/707,458

(22) PCT Filed: Nov. 25, 2022
(86) PCT No.: PCT/KR2022/018868

§ 371 Date: May 3, 2024

(30) Foreign Application Priority Data
Nov. 25, 2021 (KR) 10-2021-0164879

(51) Int. Cl. H04W 12/50; H04W 4/38; H04W 12/71

(52) U.S. Cl. CPC H04W 12/50; H04W 4/38; H04W 12/71

(57) ABSTRACT

A pairing method for a sensor and a gateway, according to one embodiment of the present invention, comprises the steps of: transmitting, to a gateway, a first pair packet including sensor information, if a pair bit is a first value; determining whether unique information included in a received second pair packet is corresponding unique information, if the second pair packet is received from the gateway; and changing the pair bit to a second value if the unique information included in the second pair packet is the corresponding unique information.

### TECHNICAL FIELD

The present invention relates to a pairing method for a sensor and a gateway, and more specifically, to a pairing method that performs pairing using a pair bit and unique information of a sensor, and to the sensor.

### BACKGROUND ART

Recently, technology development for the Internet of Things (IoT) wherein various devices such as home appliances and sensors are connected to a network and share data or sensing data is active. By using this technology, it becomes possible to equip various devices with communication and sensor functions to exchange data by themselves to process it, thereby operating it automatically. Representative examples include automobiles that can drive unmanned by checking traffic and surrounding conditions in real time, and home appliances that can be controlled with a smartphone outside the home.

In order to share data, pairing must be done between the device and the gateway, but there is a problem in that pairing involves a complicated process. In addition, when a lot of power consumption occurs during the pairing process, the operating time of a device being operated by a battery and the like may be shortened. To solve these problems, there is a need to develop technology capable of easy pairing between devices such as sensors and gateways.

### DETAILED DESCRIPTION OF THE INVENTION

### Technical Subject

The technical problem to be solved by the present invention is to provide a pairing method and a sensor that perform pairing using a pair bit and unique information of the sensor.

### Technical Solution

In order to solve the above technical problem, the pairing method for a sensor and a gateway according to an embodiment of the present invention comprises the steps of: transmitting, to a gateway, a first pair packet including sensor information, if a pair bit is a first value; determining whether unique information included in a received second pair packet is corresponding unique information, if the second pair packet is received from the gateway; and changing the pair bit to a second value if the unique information included in the second pair packet is the corresponding unique information.

In addition, the pair bit may be set to a first value initially or when a battery of the senor is mounted.

In addition, the pair bit may be stored in a static memory.

In addition, it may include a step of performing a function of the sensor if the pair bit is a second value.

In addition, it may include a step of checking the pair bit if the sensor is changed from a sleep mode to an active mode.

In addition, the sensor information includes universally unique identifier (UUID) of the sensor, wherein the unique information may include a serial number of the sensor.

In order to solve the above technical problem, the pairing method for a sensor and a gateway according to an embodiment of the present invention comprises the steps of: determining whether the received packet is a pair packet when a packet is received from a sensor; determining whether sensor information included in the received packet is registered if the packet is a pair packet; and transmitting a second pair packet including unique information of the sensor according to the registered sensor information to the sensor if the sensor information is registered.

In addition, determining whether sensor information included in the received packet is registered if the packet is not a pair packet; and transmitting sensing data included in the packet to a server if the sensor information is registered.

In order to solve the above technical problem, a sensor according to an embodiment of the present invention comprises: a communication unit transmitting and receiving packets to and from a gateway; a memory for storing a pair bit; and a processor for processing pairing with the gateway, wherein the processor: transmits a first pair packet including sensor information to the gateway, if the pair bit is a first value; when a second pair packet is received from the gateway, determines whether unique information included in the second pair packet is corresponding unique information; and if the unique information included in the second pair packet is the corresponding unique information, performs pairing by changing the pair bit to a second value.

In addition, it includes a battery supplying power to the sensor, wherein the pair bit may be set to a first value initially or when the battery is mounted.

In addition, the sensor information includes universally unique identifier (UUID) of the sensor, wherein the unique information may include a serial number of the sensor.

In addition, unique information of the sensor is stored in a gateway that registered the sensor information, and may be included in the second pair packet being received from the gateway.

### Advantageous Effects

According to embodiments of the present invention, pairing for two-way communication can be performed simply using a pair bit. In addition, security can be enhanced by using a serial number, which is a unique number of a sensor.

### BRIEF DESCRIPTION OF DRAWINGS

FIG. 1 is a block diagram of a sensor according to an embodiment of the present invention.

FIGS. 2 to 5 are diagrams for explaining a pairing process for a sensor and a gateway according to an embodiment of the present invention.

FIG. 6 is a flowchart of a pairing method for a sensor according to an embodiment of the present invention.

FIG. 7 is a flowchart of a pairing method for a gateway according to an embodiment of the present invention.

### BEST MODE

Hereinafter, preferred embodiments of the present invention will be described in detail with reference to the accompanying drawings.

However, the technical idea of the present invention is not limited to some embodiments to be described, but may be implemented in various forms, and inside the scope of the technical idea of the present invention, one or more of the constituent elements may be selectively combined or substituted between embodiments.

In addition, the terms (including technical and scientific terms) used in the embodiments of the present invention, unless explicitly defined and described, can be interpreted as a meaning that can be generally understood by a person skilled in the art, and commonly used terms such as terms defined in the dictionary may be interpreted in consideration of the meaning of the context of the related technology.

In addition, terms used in the present specification are for describing embodiments and are not intended to limit the present invention.

In the present specification, the singular form may include the plural form unless specifically stated in the phrase, and when described as “at least one (or more than one) of A and B and C”, it may include one or more of all combinations that can be combined with A, B, and C.

In addition, in describing the components of the embodiment of the present invention, terms such as first, second, A, B, (a), and (b) may be used. These terms are merely intended to distinguish the components from other components, and the terms do not limit the nature, order or sequence of the components.

And, when a component is described as being ‘connected’, ‘coupled’ or ‘interconnected’ to another component, the component is not only directly connected, coupled or interconnected to the other component, but may also include cases of being ‘connected’, ‘coupled’, or ‘interconnected’ due that another component between that other components.

In addition, when described as being formed or disposed in “on (above)” or “below (under)” of each component, “on (above)” or “below (under)” means that it includes not only the case where the two components are directly in contact with, but also the case where one or more other components are formed or disposed between the two components. In addition, when expressed as “on (above)” or “below (under)”, the meaning of not only an upward direction but also a downward direction with respect to one component may be included.

A modified embodiment according to this embodiment may include some components of each embodiment and some components of other embodiments. That is, the modified embodiment may include one of various embodiments, but some components may be omitted and some components of other corresponding embodiments may be included. Or, it could be the other way around. Features, structures, effects, and the like to be described in the embodiments are included in at least one embodiment and are not necessarily limited to only one embodiment. Furthermore, the features, structures, effects, and the like illustrated in each embodiment can be combined or modified and implemented in other embodiments by a person with ordinary knowledge in the field to which the embodiments belong. Therefore, contents related to such combinations and modifications should be interpreted as included in the scope of the embodiments.

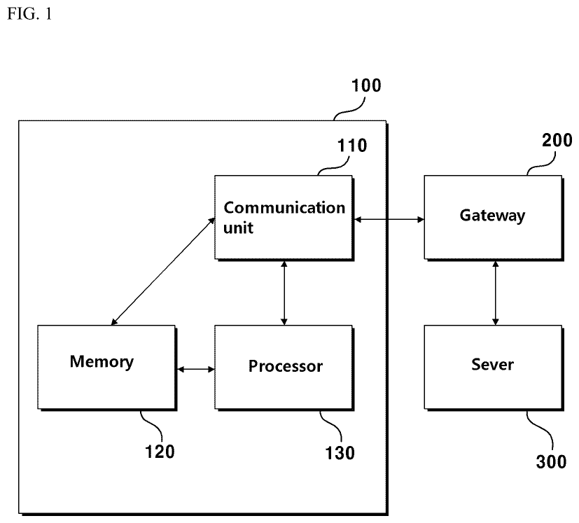

FIG. 1 is a block diagram of a sensor according to an embodiment of the present invention.

A sensor 100 according to an embodiment of the present invention is configured with a communication unit 110, a memory 120, and a processor 130, and may include a sensing unit (not shown).

The sensor 100 may be connected to the gateway 200 through wireless communication and transmit the sensed data to the gateway 200. The sensor 100 may be a sensor that senses information about an object or the outside through an applied function. The sensor 100 may be connected to the gateway 200 through wireless or wired communication. For example, the sensor 100 may be connected to the gateway 200 through LoRa communication, and may be connected through various communications other than Bluetooth or Wifi. The gateway 200 can transmit sensing data received from the sensor 100 to the server 300 or another device, and two-way communication, in which sensor control data being received from the server 300 or outside is transmitted to the sensor 100, can be performed.

Pairing must be performed for the sensor 100 and the gateway 200 to transmit and receive sensing data or control data. Here, pairing means that a plurality of devices can transmit and receive data by detecting and registering each other, and is also referred to as synchronization.

The sensor 100 uses a pair bit and a unique number to perform pairing with the gateway 200, and to process this, it includes a communication unit 110, a memory 120, and a processor 130.

The communication unit 110 transmits and receives packets to and from the gateway 200.

More specifically, the communication unit 110 transmits and receives packets containing data to and from the gateway 200 through wireless or wired communication. Here, a packet is a bundle of data that transmits data, and the communication unit 110 can transmit and receive data to and from the gateway 200 in packet units.

The memory 120 stores pair bits.

More specifically, the memory 120 stores pair bits, which are information for determining whether a pairing operation is performed. Here, a pair bit may include a first value or a second value. Here, the first value may be a state in which pairing is required or a state in which pairing is released, and the second value may be a state in which pairing is not required or a state in which pairing is set. A pair bit may be 1 bit, and may be 0 or 1. At this time, a first value may be 0 and a second value may be 1, and conversely, a first value may be 1 and a second value may be 0. Or, a pair bit includes multiple bits and may include values representing three or more states, including errors and the like.

The memory 120 may store sensing data sensed by the sensor 100 or data received from the gateway 200 or an external source. The memory 120 may be static memory, for example, SRAM. Or, it may be various types of memory, such as dynamic memory such as DRAM or flash memory and the like.

Memory 120 can store sensor information and unique information. Here, the sensor information may include a universally unique identifier (UUID) of the sensor 100. A universal unique identifier, an identifier for identifying an object in communications, is a value used to identify an object on a network, and may be a value being changed by settings or a fixed value.

The unique information may include the serial number of the sensor. The serial number is referred to as a serial number or manufacturing number, and is a number assigned to each sensor 100 when manufacturing a sensor 100 product, and is a unique value for each sensor 100. The memory 120 can store sensor information and unique information so that it can be used to perform pairing.

In addition, the memory 120 may store commands that allow the sensor 100 to perform sensing or pairing. In addition, various data necessary for the sensor 100 to operate may be stored.

The processor 130 processes pairing with the gateway 200.

More specifically, the processor 130 processes pairing with the gateway 200 using a pair bit stored in the memory 120 and packet transmission and reception with the gateway 200 through the communication unit 110. When the pair bit is a first value, the processor 130 transmits a first pair packet including sensor information to the gateway 200, and when a second pair packet is received from the gateway 200, the processor 130: transmits a first pair packet including sensor information to the gateway 200 if the pair bit is a first value; when a second pair packet is received from the gateway, determines whether a unique information included in the second pair packet is corresponding unique information; and if a unique information included in the second pair packet is corresponding unique information, performs pairing by changing the pair bit to a second value.

The processor 130 uses a pair bit stored in the memory 120 to check the value of the pair bit to determine whether pairing is performed. If a pair bit is a first value that requires pairing, the pairing process is performed. First, when a pair bit is a first value, a first pair packet including sensor information is transmitted to the gateway. Here, a first pair packet is transmitted to an outside that can be connected through pairing rather than to a specific gateway. A first pair packet may include the name of a sensor and a universal unique identifier (UUID), which is sensor information, necessary for the gateway 200 receiving it to perform pairing. Or, it may include information indicating the current state of a sensor or information indicating that it is a pair packet.

Upon receiving a second pair packet from gateway 200 intending to perform pairing with the sensor 100 by receiving a first pair packet, the processor 130 determines whether the unique information included in the received second pair packet is corresponding unique information. The first pair packet does not include unique information of the sensor, and the second pair packet includes unique information of the sensor. That is, through the process of checking whether corresponding unique information that was not transmitted through the first pair packet is included in the second pair packet, it may be determined whether the gateway 200 that transmitted the second pair packet is a suitable gateway 200 to perform pairing. If the unique information is different, the corresponding gateway may be determined to be an illegal gateway and the like that is not suitable for pairing.

If the unique information included in the second pair packet is corresponding unique information, the processor 130 changes the pair bit to a second value. If the unique information included in the second pair packet is corresponding unique information even though it is not included in a first pair packet, since the gateway knows corresponding unique information in advance, and the gateway is a gateway suitable for pairing, so the pair bit is changed to a second value, which is a value with which pairing is completed. The pairing process can be terminated by changing the pair bit to a second value. The pair bit that has been changed to a second value can be stored in the memory 120.

When a pair bit is a second value, pairing with the gateway 200 is maintained, and there is no need to perform a pairing process, so the pairing process is not performed. Through this, power consumption can be reduced by not performing unnecessary pairing processes, allowing operation at low power.

It may include a battery that supplies power to the sensor 100. While the sensor 100 is supplied with power from the battery, the pair bits stored in the memory 120 can be maintained, however, when the battery is discharged and replaced, or when the battery is installed for the first time, or during the initial operation of the sensor 100, the pair bit may be set to an initial value or a first value which is a value requiring pairing. For example, after the battery is removed, when a charged battery is connected, the pair bit may be initialized to a first value, and since the pair bit is a first value, a pairing process may be performed.

After the pairing process is performed and pairing is established between the sensor 100 and the gateway 200, the pair bit is maintained at a second value, and the sensor can perform the function of the sensor 100 without performing pairing process every time. That is, the sensor 100 can generate sensing data through sensing. The sensing data may be transmitted to the gateway 200 through the communication unit 110.

The sensor 100 may operate all the time or only when necessary. When operating only when necessary, when sensing is not required, it can operate in sleep mode to reduce power consumption. When changing to operation mode because sensing is required during sleep mode, the pair bit can be checked. In sleep mode, since the pair bit is maintained at a second value, sensing can be performed immediately without a pairing process when changing from sleep mode to operation mode.

The gateway 200, which transmits and receives packets to and from the sensor 100 during the pairing process, may operate as follows.

First, when the gateway 200 receives a packet from the sensor 100, it determines whether the received packet is a pair packet. It is possible to check whether the packet received from the sensor 100 is a pair packet for pairing or a packet containing sensing data. If the packet is a pair packet, it may include data representing the pair packet. If the packet is a pair packet, it is determined whether sensor information included in the received packet has been registered. Here, the gateway 200 may be a gateway that has previously stored information about the sensor 100. The gateway 200 stores information about the sensor 100 in advance, and when the sensor information is registered, pairing with the corresponding sensor 100 can be performed. For two-way confirmation for pairing, the gateway 200 transmits a second pair packet including unique sensor information according to the registered sensor information to the sensor 100. The gateway 200 may store unique information of the sensor according to the name of the sensor or universal unique identifier (UUID) included in the sensor information. The gateway 200 can store sensor information, and the like in a sensor DB, and at this time, the data can be stored in a table format. In this way, using the stored data, the unique information of the sensor according to the registered sensor information is read, and a second pair packet containing the unique information of the sensor is transmitted to the sensor 100, so that the sensor 100 can check itself. As described above, the sensor 100 performs pairing using a second pair packet.

If the packet received by the gateway 200 is not a pairing packet, the packet may be a sensing data packet. In this case, it is determined whether the sensor information included in the received packet is registered, and if the sensor information is registered, the sensing data included in the packet may be transmitted to a server or an external device and the like that needs the sensing data.

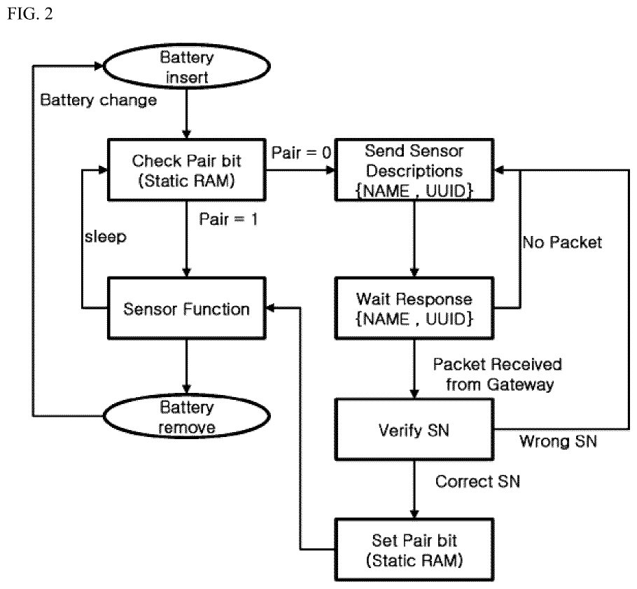

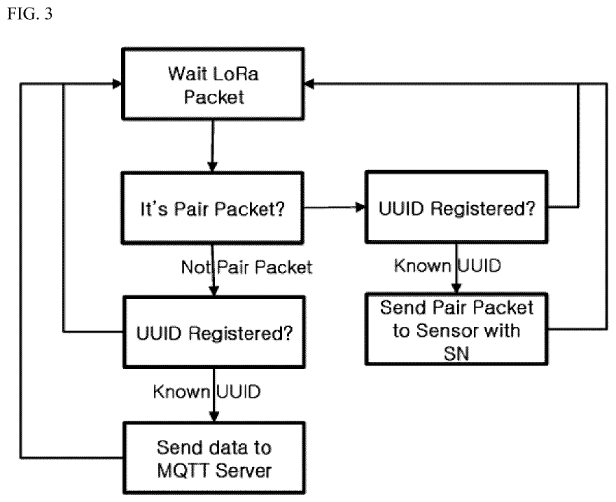

FIG. 2 illustrates a pairing process performed in a sensor, and FIG. 3 illustrates a pairing process performed in a gateway. When a battery is installed or a battery is replaced after a battery is removed, the sensor 100 checks pair bits stored in a S (static) RAM, which is a storage unit, and if the pair bit is a first value of 0, a pairing process is performed, and if the pair bit is a second value of 1, a sensor function is performed without a pairing process to generate sensing data.

When performing a pairing process, a first pairing packet including sensor description, which is sensor information, is transmitted to the outside and waited for a response thereof from the gateway 200. Upon receiving a second pairing packet, which is the corresponding response, from the gateway 200, the serial number, which is unique information included in the second pairing packet, is checked, and if the unique information matches, pairing is completed by changing the pair bit to a second value and storing it. If the unique information does not match, the pairing process is repeated without changing the pair bit.

When pairing is completed, the sensor performs a sensing operation. When it is switched to a sleep mode and then switched back to an operating mode, the pair bit is checked, and at this time, since the pair bit is maintained at a second value, and the sensing operation is performed. When pairing with the gateway 200 is released or the battery of the sensor 100 is replaced, the pair bit is changed to a first value, and pairing is performed when pairing becomes necessary.

As shown in FIG. 3, when the gateway 200 receives a LoRa packet from the sensor 100, it determines whether the packet is a pair packet, and if it is a pair packet, performs a pairing process. Since the pair packet includes a universal unique identifier (UUID), which is sensor information, it is determined whether the universal unique identifier is registered in a sensor DB. If the universal unique identifier is registered, a second pair packet including the serial number, which is the unique information of the sensor stored accordingly, is transmitted to the sensor 100. The second pair packet including the serial number is used to perform a pairing process in the sensor 100, as previously described.

If the packet received from the sensor 100 is a packet containing sensing data that is not a pair packet, it is determined whether the universal unique identifier of the corresponding sensor is registered in a sensor DB. If the universal unique identifier is registered, the sensing data is transmitted to the server. At this time, the server may be an MQTT server.

Message Queuing Telemetry Transport (MQTT) is a lightweight message transmission protocol based on push technology developed to optimize bandwidth-limited communication environments such as Machine to Machine (M2M) and the Internet of Things (IoT). Instead of the client/server method commonly used in push technology, the MQTT protocol uses a method in which the sender publishes a specific message and the receiver subscribes the message through a message broker. In other words, messages are sent and received through a broker. The smallest message length can be up to 2 bytes, and 1,000 messages can be transmitted per second, so it has the advantage of being light and fast.

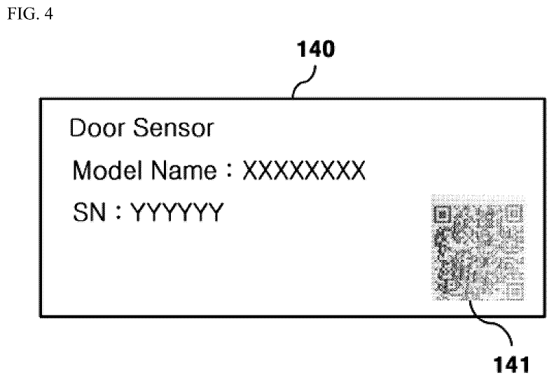

The sensor 100 can display corresponding unique information, including a serial number, on the display unit 140, as shown in FIG. 4. Unique information, including serial numbers, can be displayed in various display forms such as QR code 141 or barcode. The gateway 200 can recognize unique information displayed on the display unit 140 or register it on a sensor DB by recording it through a manual. In addition, the gateway 200 can store sensor information and unique information in a sensor DB using various methods such as Bluetooth or Wifi.

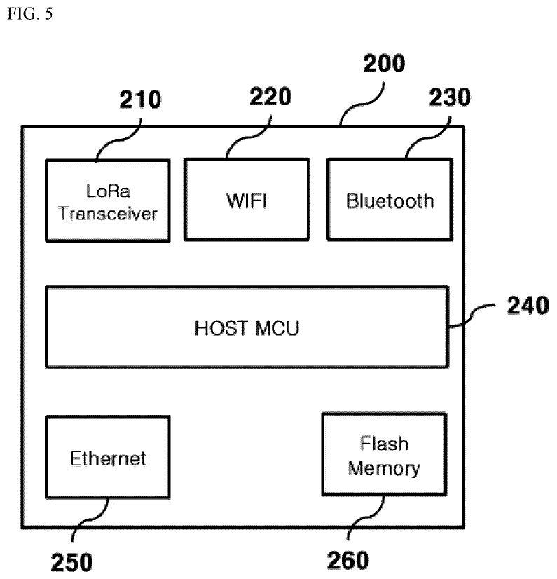

As shown in FIG. 5, the gateway 200 may include a communication unit for performing communication using various communication methods. For example, as shown in FIG. 5, it may include LoRa Transceiver 210, Wifi 220, Bluetooth 230, and Ethernet 250 modules. In addition, it may include such as an MCU 240, which is a control unit, and a Flash Memory 260, which is a memory.

The sensor DB of the gateway can add information about sensors through Bluetooth or a web interface. In cases where communication via a network is difficult, Bluetooth may be included to receive sensor data.

At this time, information stored in a sensor DB may include UUID, SN, INSTALL DATE, BATTERY LIFE, ACTIVATE, and the like. Here, UUID is the unique ID of the device for communication, and SN is a unique number required when registering a sensor. If the SN received from the gateway matches, they can operate as paired. The INSTALL DATE is the initial pair date, and BATTERY LIFE can be periodically updated with the sensor battery remaining amount. ACTIVATE may be data indicating the presence or absence of sensor data MQTT Relay. The data can be stored in a sensor DB and used to perform pairing.

As described above, simple and safe two-way pairing can be performed by using the pair bit and the unique information of the sensor, and low-power operation can be possible by not performing unnecessary pairing.

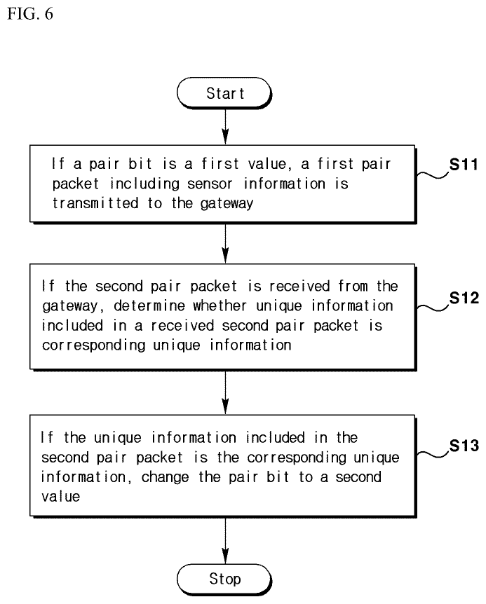

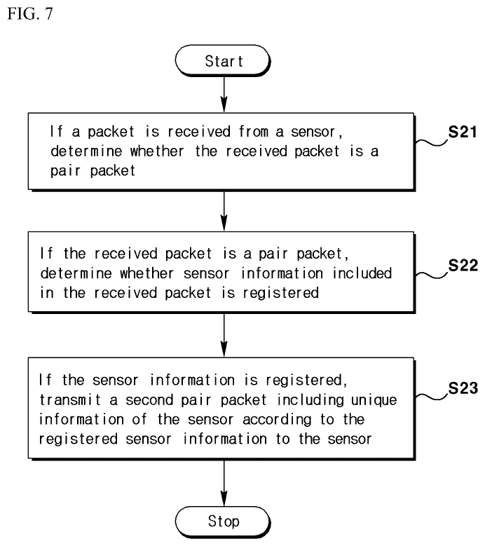

FIG. 6 is a flowchart of a pairing method for a sensor according to an embodiment of the present invention; and FIG. 7 is a flowchart of a pairing method for a gateway according to an embodiment of the present invention. The detailed description of each step in FIGS. 6 and 7 corresponds to the detailed description of the pairing process between the sensor and the gateway in FIGS. 1 to 5, and overlapping descriptions will be omitted hereinafter.

In a pairing method for a sensor and a gateway, if a pair bit is a first value, sensor information is transmitted to the gateway in step S11, and upon receiving the second pair packet from the gateway, in step S12, it is determined whether unique information included in a received second pair packet is corresponding unique information, and if the unique information included in a second pair packet is corresponding unique information, in step S13, pairing is performed by changing the pair bit to a second value.

The pair bit may be set to a first value initially or when a battery of the senor is mounted, and the pair bit may be stored in a static memory.

It may include a step of performing a function of the sensor if the pair bit is a second value, and it may include a step of checking the pair bit if the sensor is changed from a sleep mode to an active mode.

Here, the sensor information includes universally unique identifier (UUID) of the sensor, wherein the unique information may include a serial number of the sensor.

In a pairing method for a sensor and a gateway, upon receiving a packet from the sensor, in step S21, it is determined whether the received packet is a pair packet, and if the packet is a pair packet, in step S22, it is determined whether sensor information included in the received packet is registered, and if the sensor information is registered, in step S23, a second pair packet including unique information of the sensor according to the registered sensor information is transmitted to the sensor.

If the packet is not a pair packet, it may include the steps of: determining whether sensor information included in the received packet is registered if the packet is not a pair packet; and transmitting sensing data included in the packet to a server if the sensor information is registered.

A person skilled in the art related to this embodiment will understand that the above-described descriptions can be implemented in a modified form without departing from the essential characteristics. Therefore, the disclosed methods should be considered from an explanatory rather than a restrictive perspective. The scope of the present invention is indicated in the claims rather than the foregoing description, and all differences within the equivalent scope should be construed as being included in the present invention.

1. A pairing method for a sensor and a gateway comprising the steps of:
transmitting, to a gateway, a first pair packet comprising sensor information, if a pair bit is a first value;
determining whether unique information comprised in a received second pair packet is corresponding unique information, if the second pair packet is received from the gateway; and
changing the pair bit to a second value if the unique information comprised in the second pair packet is the corresponding unique information.

2. The pairing method according to claim 1,
wherein the pair bit is set to a first value initially or when a battery of the senor is mounted.

3. The pairing method according to claim 1,
wherein the pair bit is stored in a static memory.

4. The pairing method according to claim 1, comprising the step of:
performing a function of the sensor if the pair bit is the second value.

5. The pairing method according to claim 1, comprising the step of:
checking the pair bit if the sensor is changed from a sleep mode to an active mode.

6. The pairing method according to claim 1,
wherein the sensor information comprises universally unique identifier (UUID) of the sensor, and
wherein the unique information comprises a serial number of the sensor.

7. A pairing method for a sensor and a gateway, comprising the steps of:
determining whether a received packet is a pair packet if the packet is received from a sensor;
determining whether sensor information comprised in the received packet is registered if the packet is a pair packet; and
transmitting, to the sensor, a second pair packet comprising unique information of the sensor according to the registered sensor information if the sensor information is registered.

8. The pairing method according to claim 7, comprising the steps of:
determining whether sensor information comprised in the received packet is registered if the packet is not a pair packet; and
transmitting, to a server, sensing data comprised in the packet if the sensor information is registered.

9. A sensor comprising:
a communication unit configured to transmit and receive a packet to and from a gateway;
a memory configured to store a pair bit; and
a processor configured to process pairing with the gateway,
wherein the processor:
transmits, to the gateway, a first pair packet comprising sensor information if a pair bit is a first value;
determines whether unique information comprised in a second pair packet is corresponding unique information if the second pair packet is received from the gateway; and
performs pairing by changing the pair bit to a second value if the unique information comprised in the second pair packet is the corresponding unique information.

10. The sensor according to claim 9, comprising:
a battery supplying power to the sensor,
wherein the pair bit is set to a first value initially or when the battery is mounted.

11. The sensor according to claim 9,
wherein the memory comprises a static memory.

12. The sensor according to claim 9, comprising:
a sensing unit performing a function of the sensor if the pair bit is the second value.

13. The sensor according to claim 9,
wherein the processor checks the pair bit if the sensor is changed from a sleep mode to an active mode.

14. The sensor according to claim 13,
wherein the pair bit is set as the second value in the sleep mode.

15. The sensor according to claim 14,
wherein the processor performs a function of the sensor without performing pairing when the sensor is changed from the sleep mode to the active mode.

16. The sensor according to claim 9,
wherein the sensor information comprises universally unique identifier (UUID) of the sensor.

17. The sensor according to claim 9,
wherein the unique information comprises a serial number of the sensor.

18. The sensor according to claim 9,
wherein the unique information of the sensor is stored in the gateway registering the sensor information and comprised in the second pair packet received from the gateway.

19. The sensor according to claim 9,
wherein the gateway:
determines whether a received packet is a pair packet if the packet is received from the sensor;
determines whether sensor information comprised in the received packet is registered if the packet is a pair packet; and
transmits, to the sensor, a second pair packet comprising unique information of the sensor according to the registered sensor information if the sensor information is registered.

20. The sensor according to claim 19,
wherein the gateway:
determines whether sensor information comprised in the received packet is registered if the packet is not a pair packet; and
transmits, to a server, sensing data comprised in the packet if the sensor information is registered.
